(19) United States
(12) Patent Application Publication
(10) Pub. No.: US 2018/0179399 A1
(43) Pub. Date: Jun. 28, 2018

(54) Reinforced Polymer Coating

(71) Applicant: Hardshell UK Limited, Penarth (GB)

(72) Inventor: Anil Kant, Penarth (GB)

(21) Appl. No.: 15/851,460

(22) Filed: Dec. 21, 2017

(30) Foreign Application Priority Data
Dec. 22, 2016 (GB) 1622030.3

(51) Int. Cl. C09D 7/61; C09D 175/02; C09D 7/40; C08G 18/08; C08G 18/10; C08G 18/48; C08G 18/32; C08G 18/76; B05D 1/02

(52) U.S. Cl. CPC C09D 7/61; C09D 175/02; C09D 7/69; C09D 7/70; C08G 18/0838; C08G 18/10; C08K 7/26; C08G 18/324; C08G 18/3228; C08G 18/7621; C08G 18/7671; B05D 1/02; C08G 18/4854

(57) ABSTRACT

A coating is made by mixing an amine-terminated polymer precursor; an aromatic polyisocyanate polymer precursor; and nanotubes in the head of a spray gun and spraying the mixture onto a substrate.

### CROSS-REFERENCE TO RELATED APPLICATION

This claims priority to United Kingdom Patent Application No. GB 1622030.3, filed Dec. 22, 2016, which is incorporated herein by reference in its entirety.

### FIELD

The present invention relates to nanotube-reinforced polyurea coatings and methods for producing them.

### BACKGROUND

Polyurea is a thermoset elastomer that is derived from the reaction of an isocyanate component and an amine-terminated polymer resin. Polyurea displays high impact resistance: this is considered to be due to its good tensile strength which may be, for example, over 20 MPa, or even over 30 MPa, combined with an elongation to failure that may be, for example, over 250%.

Thus, it is known to use polyurea coating films in applications where components are required to resist very high impact and tension forces, such as those encountered in blasts, ballistic events and natural disasters. Such coatings may be applied through spray coating, as this is known to be fast and to be applicable to a wide range of surface topographies.

It is desirable to improve the properties of these coatings yet further, while retaining the ability to apply them through spray coating.

### SUMMARY

Therefore, at its most general, the present invention may provide a coating having a matrix of polyurea and nanotubes embedded therein, the coating being configured such that it may be applied through a spray coating procedure.

Nanotubes are tubular structures having a diameter that is less than 1 micron, typically less than 500 nm, and in certain cases less than 200 nm or possibly less than 100 nm. The nanotubes may be organic (e.g. carbon nanotubes) or inorganic.

Inorganic nanotubes may be available in geological deposits or in synthetic form.

In general, the presence of nanotubes within the coating has been found to increase the tensile strength and tear strength of the coating, while retaining a thermally stable coating for which elongation to failure remains at acceptable levels.

It has been found that in order for a coating to be applied to a substrate through a spray coating procedure, it must be capable of rapid gelling. In the case of a coating having a matrix of polyurea, it has been found that this requires the polyurea to be prepared through the reaction of an amine-terminated polymer precursor with an aromatic (rather than aliphatic) polyisocyanate polymer precursor.

Therefore, in a first aspect, the present invention may provide a method of making a coating, comprising the step of providing a mixture comprising:
an amine-terminated polymer precursor;
an aromatic polyisocyanate polymer precursor; and nanotubes
   in the head of a spray gun and spraying the mixture onto a substrate.

A polymer precursor is a system of unreacted or partially-reacted monomers, for example, a prepolymer system.

The aromatic polyisocyanate polymer precursor may comprise toluene diisocyanate and/or methylene diphenyl diisocyanate, preferably methylene diphenyl diisocyanate, more preferably methylene diphenyl 4,4′-diisocyanate.

Preferably, the amine-terminated polymer precursor comprises a primary amine. Typically, the amine-terminated polymer precursor is a blend of different types of primary amine compounds.

The polymer precursor may contain molecules of various different polymer groups, for example, the aromatic polyisocyanate polymer precursor may comprise additionally polyol monomers and/or polyurethane (polyurethane being the product of the reaction between polyol groups and isocyanate groups).

Preferably, the nanotubes are negatively charged at the external surface of the tube and positively charged at the internal surface of the tube. This electronic structure results in nanotubes having an even dispersion within the polymer matrix, particularly when relatively high amounts are present within the matrix (for example, more than 2 wt %).

Preferably, the inorganic nanotubes are aluminosilicate nanotubes, in particular, halloysite nanotubes. Halloysite is a kind of two-layered aluminosilicate clay mineral, generally comprising alternating alumina octahedron sheets and silica tetrahedron sheets that are rolled (naturally and/or synthetically) to provide a tubular structure. Halloysite is an example of a nanotube having a negative charge at its external surface and a positive charge at its internal surface. This represents a benefit of halloysite nanotubes compared to other nanofillers such as layered silicates, for example montmorrillonite.

The halloysite may be a natural halloysite or a modified natural halloysite. It may be present in the metahydrate form (Al₂Si₂O₅(OH)₄.2H₂O) or the Endellite form (Al₂Si₂O₅(OH)₄.4H₂O).

Typically, the halloysite nanotubes have an average length in the range 200-2000 nm, preferably 200-800 nm. However, in certain cases, the halloysite nanotubes have a mean average length of at least 5 μm, preferably at least 7.5 μm, more preferably at least 10 μm. In such cases, the mean average length of the halloysite nanotubes is generally less than 30 μm.

Typically, the halloysite nanotubes have an average external diameter in the range 20-200 nm, preferably 20-100 nm. In certain cases, the halloysite nanotubes have a mean average external diameter of 70 nm or less, preferably 50 nm or less, most preferably 40 nm or less. In such cases, the mean average diameter of the halloysite nanotubes may be as low as 20 nm.

Typically, the halloysite nanotubes have a mean average inner diameter in the range 5-50 nm, preferably 5-20 nm.

Preferably, the halloysite nanotubes have an aspect ratio of at least 15, preferably at least 50, more preferably at least 75, most preferably at least 100. Such nanotubes may be available from e.g. I-Minerals Inc (in the form of a variety known as “long and thin” halloysite nanotubes) or from e.g. Siberia, 85 km NW of Kalgoorlie, Western Australia (in the form of a variety known as “patchy and lengthy” halloysite nanotubes).

Such high aspect halloysite nanotubes have been found to increase both tensile strength and elongation to failure. More specifically the presence of long tubes is thought to support the polymer chains of the polyurea matrix during any developing rupture process, so as to allow greater elongation of the coating before any final failure event.

Furthermore, such high aspect ratio halloysite nanotubes generally have fibrous characteristics (for example, they have high flexibility), with the result that they may readily become entangled to form a “bird's nest” structure. The resulting network of entangled tubes may allow applied forces to be distributed over large sections of the coating, thus further helping to improve the tensile strength of the coating and/or the elongation to failure.

The halloysite nanotubes embedded in the polymer matrix may include small amounts of impurities, such as Gibbsite, Kaolinite, and/or quartz. Preferably, the impurities are present in an amount not greater than 10 wt % relative to the halloysite content.

As an alternative to halloysite, sepiolite nanotubes or palygorskite nanotubes may be used.

In general, the nanotube content of the coating lies in range 1-7 wt %, preferably 2-6 wt %.

Typically, the coating has a thickness of 1.5 to 3 mm.

Typically, the nanotubes are dispersed in the amine-terminated polymer precursor before the amine-terminated polymer precursor is fed to the head of the spray gun. Preferably, this step comprises mechanically mixing the nanotubes into the polymer precursor for at least 1 hour, preferably at least 2 hours.

Typically, the ratio of unreacted amine groups in the amine-terminated polymer precursor to unreacted polyisocyanate groups in the polyisocyanate polymer precursor lies in the range 2:1 to 1:2, preferably around 1:1.

Preferably, the coating sets (that is, it achieves a viscosity of at least 3 Pa·s, preferably at least 5 Pa·s) within 5 minutes of being sprayed on the surface, preferably within 1 minute, more preferably within 30 s.

In general, the mixture is sprayed at a pressure in the range of 10-30 MPa, preferably 14-24 MPa.

In general, the mixture is heated to a temperature in the range 60-90° C., preferably 70-80° C. before being sprayed onto the substrate.

In a second aspect, the present invention may provide a coating comprising a polyurea matrix having halloysite nanotubes embedded therein, the halloysite nanotubes having an aspect ratio of at least 15, preferably at least 50, more preferably at least 75, most preferably at least 100.

In a third aspect, the present invention may provide a coating comprising a polyurea matrix having halloysite nanotubes embedded therein, the halloysite nanotubes having a mean average length of at least 5 μm, preferably at least 7.5 μm, more preferably at least 10 μm.

In a fourth aspect, the present invention may provide a coating comprising a polyurea matrix having halloysite nanotubes embedded therein, the halloysite nanotubes having a mean average external diameter of 70 nm or less, preferably 50 nm or less, most preferably 40 nm or less.

The halloysite nanotubes of the coatings of the second, third, and/or fourth aspects of the invention may have one or more of the features of the halloysite nanotubes used in the method of the first aspect of the invention.

The polyurea matrix of the coatings of the second, third, and/or fourth aspects of the invention may have one or more of the features of the polyurea matrix produced using the method of the first aspect of the invention.

Typically, the coating of the second, third, and fourth aspects of the invention is prepared using the method of the first aspect of the invention, which may include one or more optional features of the method of the first aspect of the invention.

Typically, the coating of the second, third, and fourth aspects of the invention has a thickness of 1.5 to 3 mm.

Typically, the coating of the second, third, and fourth aspects of the invention has a nanotube content in the range 1-7 wt %, preferably 2-6 wt %.

### BRIEF DESCRIPTION OF THE DRAWINGS

The invention will now be described by way of example with reference to the following figures in which:

FIG. 1 shows a graph of differential scanning calorimetry data obtained from different samples;

FIG. 2 shows a graph of thermogravimetric data obtained from different samples;

FIG. 3 shows a scanning electron micrograph of the surface of Example 2;

FIG. 4A shows a scanning electron micrograph of thin and long halloysite nanotubes with aspect ratio more than 50, the halloysite being available as Ultrahallopure from I-Minerals Inc.;

FIG. 4B shows a scanning electron micrograph of thin and long halloysite nanotubes with aspect ratio more than 50, the halloysite being available as “patch halloysite” from Western Australia.

FIG. 4C shows a scanning electron micrographs of thin and long halloysite nanotubes with aspect ratio more than 50, the halloysite being available as “patch halloysite” from Western Australia.

FIG. 4D shows a scanning electron micrographs of thin and long halloysite nanotubes with aspect ratio more than 50, the halloysite being available as “patch halloysite” from Western Australia.

### DETAILED DESCRIPTION OF EXAMPLE EMBODIMENTS

Reinforced polyurea samples were prepared as follows:
a. Halloysite nanotubes were mechanically mixed with a polyetheramine-based polymer precursor mixture (Component B) for four hours;
b. The polyetheramine-based polymer precursor mixture, including the dispersed nanotubes is fed to a spray system (Graco H-XP3), along with a diisocyanate-based mixture (Component A). Component A and Component B are fed into the spray system in a 1:1 ratio by weight;
c. The two components are made to travel along 15 m of reactor-heated hose (or 122 m of reactor-heated hose, in the case of Examples 5 and 6) and are mixed in the head of a hot gun located at the outlet of the hose. The mixture is brought to a temperature in the range 65-75° C. and is sprayed onto a substrate at a pressure in the range 17-21 MPa. The gelling time of the mixture is around 15 seconds.

The properties of the halloysite nanotubes are set out in Tables 1 and 2, while the properties and composition of Components A and B are set out in Tables 3 and 4 (Table 4 shows the preferred composition for Components A and B).

### Examples

Example 1 contained 2.5 wt % halloysite nanotubes from Applied Minerals Inc.

Example 2 contained 5 wt % halloysite nanotubes from Applied Minerals Inc.

Example 3 contained 7.5 wt % halloysite nanotubes from Applied Minerals Inc.

Example 4 contained 10 wt % halloysite nanotubes from Applied Minerals Inc.

Example 5 contained 5 wt % “patch halloysite” nanotubes from Western Australia

Example 6 contained 5 wt % Ultra Hallopure halloysite nanotubes from I-Minerals.

Comparative Example 1 contained no halloysite nanotubes.

### Tensile Strength and Tear Strength Testing

Dog bone-shaped samples for tensile strength and tear strength testing were prepared using metallic cutters, using a pneumatic cut machine based on ISO 37 for tensile testing and one based on ASTM 624 C for tear strength testing.

Tensile strength and tear strength tests were performed on 10 samples for each composition and test type, using an Instron 5596 universal testing machine.

The results are given in Table 5.

### Hardness Testing

The shore A hardness of polyurea samples containing with different percentages of halloysite nanotubes was evaluated using a digital hardness shore A durometer in line with ASTM D2240. 10 measurements were carried out on each sheet, to obtain the average hardness.

The results are given in Table 5.

### Thermal Properties

The thermal properties of polyurea nanocomposite samples containing different percentages of halloysite nanotubes were evaluated through differential scanning calorimetry (DSC) and thermogravimetric analysis (TGA).

Differential scanning calorimetry was carried out using a DSC-7 calorimeter from Perkin Elmer, Inc. fitted with a refrigerated cooler. The samples were heated from 20° C. to 360° C. at a rate of 10° C./min under a nitrogen flow of 20 mL/min. Each sample weighed between 6.1 and 6.7 mg, and was put in an aluminium crucible and closed by pressing an aluminium cap.

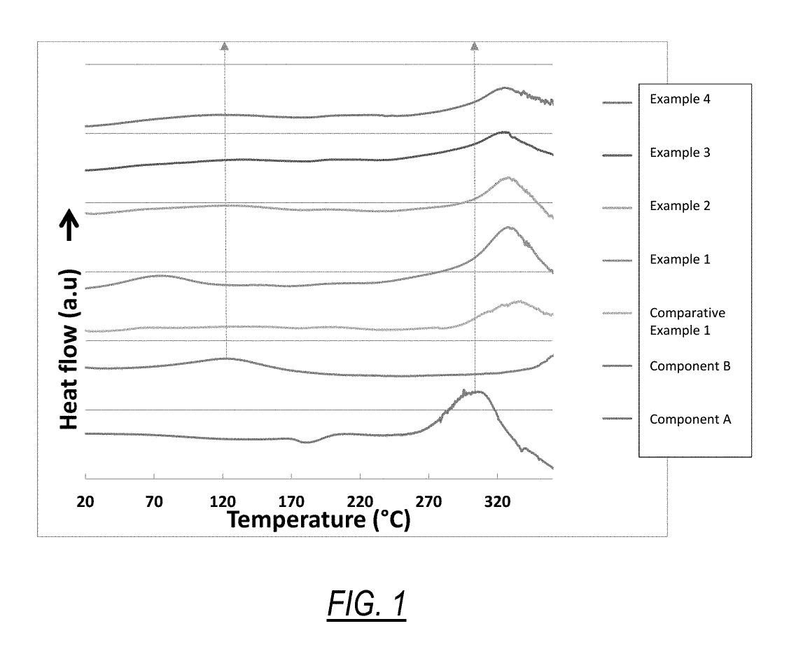

The results are shown in FIG. 1, from which it can been seen that the thermograms for Examples 1-4 and Comparative Example 1 all have a distinctive peak at about 330° C. This indicates that the presence of halloysite nanotubes would not be expected to have a significant effect on the heat flow in polyurea samples during manufacturing.

Thermogravimetric analysis was carried out by heating the samples from 25° C. to 700° C. at a rate of 10° C./min under a nitrogen atmosphere followed by heating the samples from 700° C. to 900° C. at a rate of 10° C./min under an oxygen atmosphere.

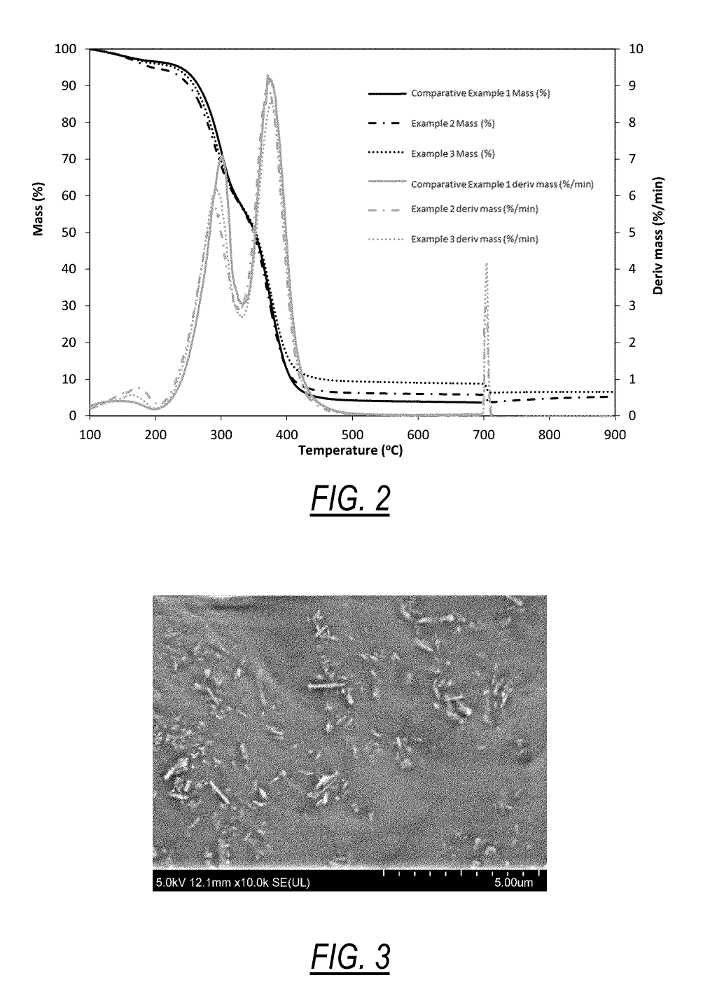

The results are shown in FIG. 2, from which it can be seen that there is good overlap between the curves obtained from Examples 2 and 3 and Comparative Example 1 (the additional peak observed at about 700° C. in the derivative mass curves for Examples 2 and 3 is due to the char residue from the halloysite nanotubes). This shows that the presence of halloysite nanotubes does not affect the thermal stability or decomposition temperature of polyurea samples.

### Scanning Electron Microscopy

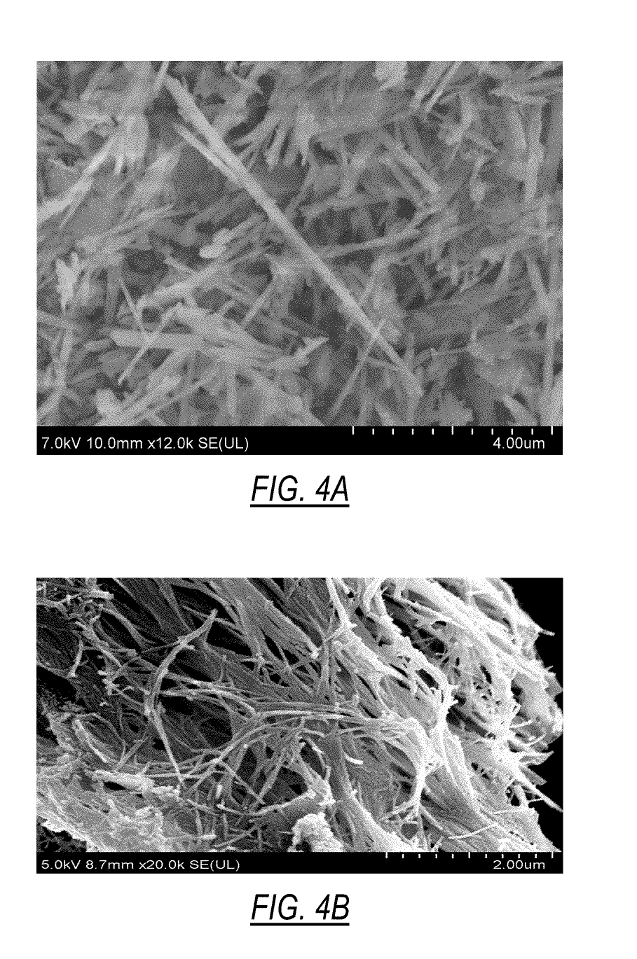

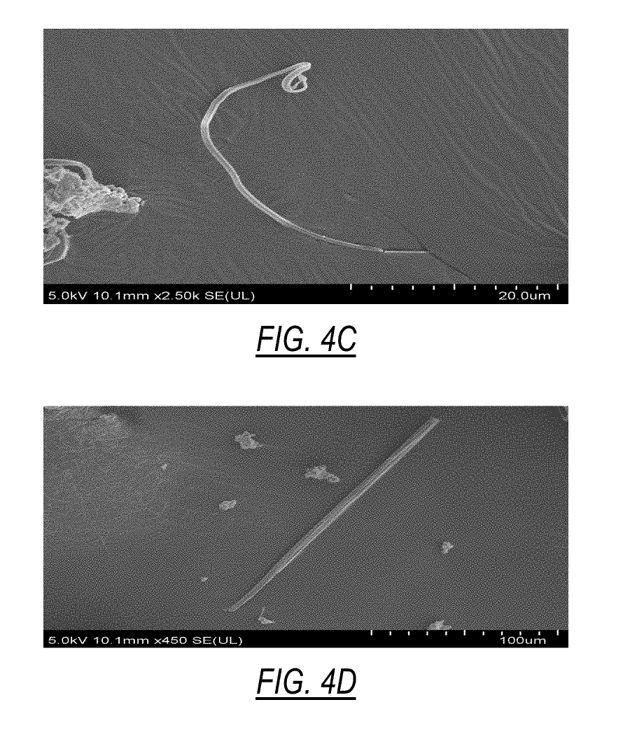

FIG. 3 shows that the halloysite nanotubes are dispersed within the polyurea matrix, rather than being present in clumps.

TABLE 1

| | | | Average | Average | | | |
|---|---|---|---|---|---|---|---|
| | Surface | Average | inner | external | Average | | |
| | area | length | diameter | diameter | lumen space | Aspect | Density |
| Nanofiller | (m²/g) | (nm) | (nm) | (nm) | volume (%) | ratio | (g/cm³) |
| Halloysite | 65 | 500 | 20 | 50 | 22 | 9 | 2.53 |
| nanotubes | | | | | | | |
| (Examples | | | | | | | |
| 1-4) | | | | | | | |

TABLE 2

| | Range of | | Range of | Range of | | | |
|---|---|---|---|---|---|---|---|
| | Surface | Range of | Inner | External | Range of | Range of | |
| | area | length | diameter | diameter | lumen space | aspect | Density |
| Nanofiller | (m²/g) | (nm) | (nm) | (nm) | volume (%) | ratio | (g/cm³) |
| Halloysite | 40-80 | 500-30,000 | 5-20 | 20-200 | 15-40 | >15 | 2.53 |
| nanotubes | | | | | | | |
| (Examples 5 | | | | | | | |
| and 6) | | | | | | | |

TABLE 3
Properties and composition of Components A and B
(Examples 1-4 and Comparative Example 1)

| Name of | | |
|---|---|---|
| product | Component A | Component B |
| Chemical | 4,4 Methylene Diphenyl | Jeffamine D2000 |
| ingredients | Diisocyanate, 20-30 wt % | Polyetheramine, 50-60 wt % |
| | Toluene Diisocyanate - | Jeffamine T5000 |
| | Polytetramethylene Etl | Polyetheramine, 3-10 wt % |
| | Glycol, (PTMEG) | Diethyltoluenediamine, |
| | 50-70 wt % | 20-30 wt % |
| | Propylene carbonate, | Carbon black N550, |
| | 5-9 wt % | 01-1 wt % |
| Viscosity | 1.800 ± 0.1 | 0.225 ± 0.025 |
| (Pa · s) | | |

TABLE 4
Properties and composition of Components A and B
(Examples 5 and 6).

| Name of | | |
|---|---|---|
| product | Component A | Component B |
| Chemical | MDI (methylene diphenyl | Jeffamine D2000 |
| ingredients | diisocyanate) prepolymer, | Polyetheramine, 65 wt % |
| | 32 wt % with NCO of 18.7 | Jeffamine T5000 |
| | TDI (toluene diisocyanate) | Polyetheramine, 5 wt % |
| | prepolymer, 63 wt % with | Jeffamine D-230 |
| | NCO of 15.5 | Polytheramine, 6 wt % |
| | Propylene carbonate, | Ethacure 100′ 19 wt % |
| | 5 wt % | Tegoamin BDE, 1 wt % |
| | | Tinuvin 1130, 2 wt % |
| | | Tinuvin 292, 2 wt % |
| | | Carbon black N550, 01-1 phr |
| Viscosity | 1.800 ± 0.1 | 0.225 ± 0.025 |
| (Pa · s) | | |

TABLE 5

| | Tensile | | Hardness | Modulus | Modulus | Modulus | Tear |
|---|---|---|---|---|---|---|---|
| | strength | Maximum | (Shore | at 0.7 | at 1.4 | at 2.1 | Strength |
| | (MPa) | Elongation % | A) | (MPa) | (MPa) | (MPa) | (N/mm) |
| Comparative | 9 ± 1 | 384 ± 26 | 92 ± 2 | 5 ± 0.5 | 7 ± 0.5 | 8 ± 0.5 | 72 ± 4 |
| Example 1 | | | | | | | |
| Example 2 | 21 ± 2 | 478 ± 25 | 99 ± 2 | 9 ± 1 | 12 ± 2 | 15 ± 2 | 120 ± 5 |
| Example 5 | 27 ± 5 | 520 ± 32 | 99 ± 2 | 9 ± 1 | 12 ± 2 | 15 ± 2 | 135 ± 8 |
| Example 6 | 30 ± 2 | 504 ± 25 | 99 ± 2 | 10 ± 1 | 14 ± 2 | 16 ± 2 | 130 ± 7 |
| % increase of | 143 | 24 | 9 | 69 | 76 | 88 | 67 |
| Example 2 relative | | | | | | | |
| to Comparative | | | | | | | |
| Example 1 | | | | | | | |
| % increase of | 200 | 35 | 8 | 80 | 71 | 88 | 88 |
| Example 5 relative | | | | | | | |
| to Comparative | | | | | | | |
| Example 1 | | | | | | | |
| % increase of | 233 | 31 | 8 | 100 | 100 | 100 | 81 |
| Example 6 relative | | | | | | | |
| to Comparative | | | | | | | |
| Example 1 | | | | | | | |

That which is claimed is:

1. A method of making a coating, comprising the steps of
providing a mixture comprising an amine-terminated polymer precursor; an aromatic polyisocyanate polymer precursor; and nanotubes
in the head of a spray gun; and
spraying the mixture onto a substrate.

2. The method of claim 1, wherein the aromatic polyisocyanate polymer precursor comprises isotoluene diisocyanate.

3. The method of claim 1, wherein the aromatic polyisocyanate polymer precursor comprises methylene diphenyl diisocyanate.

4. The method of claim 3, wherein the aromatic polyisocyanate polymer precursor comprises methylene diphenyl 4,4′-diisocyanate.

5. The method of claim 1, wherein the amine-terminated polymer precursor comprises a primary amine.

6. The method of claim 1, wherein the nanotubes are inorganic nanotubes, preferably phyllosilicate nanotubes.

7. The method of claim 6, wherein the nanotubes are at least one of halloysite, sepiolite, or palygorskite nanotubes.

8. The method of claim 7, wherein the nanotubes are natural halloysite nanotubes.

9. The method of claim 7, wherein the nanotubes are modified halloysite nanotubes.

10. The method of claim 8, wherein the halloysite is present in the metahydrate form.

11. The method of claim 8, wherein the halloysite is present in the Endellite form.

12. The method of claim 8, wherein the halloysite nanotubes have an average length of at least 7.5 μm.

13. The method of claim 8, wherein the halloysite nanotubes have an aspect ratio of at least 75.

14. The method of claim 1, wherein the nanotubes are negatively charged at the external surface of the tube and positively charged at the internal surface of the tube.

15. The method of claim 1, further comprising the step, before the step of providing the mixture in the head of the spray gun, of dispersing the nanotubes in the amine-terminated polymer precursor to create a dispersion.

16. The method of claim 1, wherein the mixture is heated to a temperature in the range 60-90° C.

17. The method of claim 1, wherein the ratio of unreacted amine groups in the amine-terminated polymer precursor to unreacted polyisocyanate groups in the aromatic polyisocyanate polymer precursor lies in the range 2:1 to 1:2.

18. The method of claim 1, wherein the aromatic polyisocyanate polymer precursor comprises polyol monomers and/or polyurethane.

19. A coating comprising a polyurea matrix having halloysite nanotubes embedded therein, the halloysite nanotubes having an aspect ratio of at least 75.

20. A coating comprising a polyurea matrix having halloysite nanotubes embedded therein, the halloysite nanotubes having a mean average length of at least 7.5 μm.
